(19) United States
(12) Patent Application Publication
(10) Pub. No.: US 2025/0317760 A1
(43) Pub. Date: Oct. 9, 2025

(54) Near Real Time Geo Location For UE Based On RAN Measurements

(71) Applicant: Parallel Wireless, Inc., Nashua, NH (US)

(72) Inventors: David Khemelevsky, Kfar Sava (IL); Sergey Antoniuk, Hod Hasharon (IL); Netanel Gabizon, Salit (IL)

(21) Appl. No.: 19/173,753

(22) Filed: Apr. 8, 2025

Related U.S. Application Data
(60) Provisional application No. 63/575,895, filed on Apr. 8, 2024.

(51) Int. Cl. H04W 24/02; H04W 64/00

(52) U.S. Cl. CPC H04W 24/02; H04W 64/00

(57) ABSTRACT

In an aspect, a method of improving a radio access network (RAN) is provided. The method comprises receiving, by a network entity (e.g., a near real-time RAN intelligent controller), first data collected in real time of at least one user equipment (UE) attached to the RAN, receiving, by the network entity, second data collected in real time by at least one RAN node of the at least one UE, and based on the first and second data, estimating a UE location and UE mobility type for the at least one UE. The first data is at least two of: IQ samples from a radio front end, sounding reference signal (SRS) data, functional application platform interface (FAPI) messaging, radio link control (RLC) data, or medium access control (MAC) data. Numerous other aspects are provided.

### CROSS-REFERENCE TO RELATED APPLICATIONS

The present application claims the benefit of priority under 35 U.S.C. § 119 (e) to U.S. Provisional App. No. 63/575,895, filed Apr. 8, 2024 and having the title “Near Real Time Geo Location For UE Based On RAN Measurements,” which is also hereby incorporated by reference in its entirety for all purposes. This application also hereby incorporates by reference in their entirety, each of the following U.S. Patent Application Publications in their entirety: US20190243836A1, US20210360552A1, US20230269633A1, and US20230291646A1. Features and characteristics of and pertaining to the systems and methods described in the present disclosure, including details of the multi-RAT nodes and the gateway described herein, are provided in the documents incorporated by reference.

In addition, the following specification documents are also incorporated by reference in their entirety: O-RAN A1 interface: Application Protocol 3.0-November 2020 (ORAN.WG2.A1AP-v03.00); O-RAN A1 interface: General Aspects and Principles 2.01-November 2020 (ORAN.WG2.A1GAP-v02.01); O-RAN Near-RT RAN Intelligent Controller Near-RT RIC Architecture 1.01-November 2020 (O-RAN.WG3.RICARCH-v01.01); O-RAN Near-Real-time RAN Intelligent Controller Architecture & E2 General Aspects and Principles 1.01-July 2020 (O-RAN.WG3.E2GAP-v01.01); O-RAN A1 interface: Transport Protocol 1.0-October 2019 (ORAN-WG2.A1.TP-v01.00); IETF RFC 6241 (NETCONF).

### BACKGROUND

Radio access networks (RANs) may not be deployed and/or configured in an efficient manner. Additionally or alternatively, over time a deployed RAN may begin to operate inefficiently. Open RAN is the movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

CU function is split into CU-CP (Control Plane) and CU-UP (User Plane) function to provide Control and User Plane separation. Open RAN solution needs to support: Open Interfaces between different functions; Software based functions; Cloud Native functions; Intelligence support via support for xApps/rApps; 3rd Party RRHs; Disaggregated functions; White Box COTS hardware support; and Data Path separated from Control plane traffic. The E2 interface is defined between CU-CP, CU-UP, O-DU, O-eNB, and Near-RT RIC.

Open RAN is an emerging technology in mobile telecoms. Open RAN has potential to bring multiple vendors to provide solution flexibility, new capabilities, and various optimizations to the network. Near-RT-RIC is a platform which provides infrastructure to host various performance optimization and value added xApps to improve RAN performances and optimizations. Various xApps are getting deployed on Near RT RIC for optimization and performances of E2 nodes such as eNB, gNBs, CU or DU. Methods and apparatus for improving a RAN (e.g., using near-RT-RIC) are desired.

### SUMMARY

In an aspect, a method of improving a radio access network (RAN) is provided. The method comprises receiving, by a network entity (e.g., a near real-time-RAN intelligent controller (near-RT RIC)), first data collected in real time by at least one user equipment (UE) coupled to the RAN, receiving, by the network entity, second data collected in real time by at least one RAN node, based on the first and second data, estimating a UE location and UE mobility type for the at least one UE, wherein the first data is at least two of: IQ samples from a radio front end, sounding reference signal (SRS) data, functional application platform interface (FAPI) messaging, radio link control (RLC) data, or medium access control (MAC) data. The method may further comprise, based on estimating the location and mobility type for the at least one UE, changing at least one RAN parameter in real time to improve the RAN.

The method may further comprise including IQ samples from a radio front end and at least one of: sounding reference signal (SRS) data, O-RAN functional application platform interface (FAPI) messaging, radio link control (RLC) data, or medium access control (MAC) data. The method may further comprise using an E2 interface agent to send the UE data to the network entity (e.g., radio access network intelligent controller (RIC)) and to receive configuration information based on UE geolocation information received at or determined at the RIC. The UE data may be sent to a data analytics provider in the operator core network and further processed to determine UE location. The method may further comprise performing data cleansing and extraction, transformation and loading (ETL) of the UE data at the network entity (e.g., RIC), and sending cleansed data to a service management and orchestration (SMO) server in the core network. The method may further comprise using data lake storage for accumulating UE data over a period of multiple weeks and using data lake compute for analyzing traffic patterns over the period of multiple weeks. The method may further comprise performing collection of UE data at the base station using observability hooks during code execution. The method may further comprise using at least one of a neural network, a machine learning model, and an inference model for UE classification or location prediction. The method may further comprise using individual neural networks, machine learning models, or inference models for each of a plurality of cell sectors. The method may further comprise classifying a UE as a cell edge UE based on using at least one of a neural network, a machine learning model, and an inference model.

In another aspect, a non-transitory computer-readable medium comprising instructions for improving a radio access network (RAN) is provided. The instructions, when executed, cause a system to perform steps, comprising receiving, by a network entity (e.g., near-RT RIC), first data collected in real time by at least one user equipment (UE) coupled to the RAN, receiving, by the network entity, second data collected in real time by at least one RAN node, based on the first and second data, estimating a UE location and UE mobility type for the at least one UE, wherein the first data is at least two of: IQ samples from a radio front end, sounding reference signal (SRS) data, functional application platform interface (FAPI) messaging, radio link control (RLC) data, and medium access control (MAC) data. The medium may further comprise instructions for, based on estimating the location and mobility type for the at least one UE, changing at least one RAN parameter in real time to improve the RAN. In another aspect, a network entity (e.g., a near-RT RIC) is provided. The network entity comprises a memory and a processor coupled to the memory, the processor configured to receive first data collected in real time of at least one user equipment (UE) attached to the RAN, receive second data collected in real time by at least one RAN node of the at least one UE, and based on the first and second data, estimate a UE location and UE mobility type for the at least one UE. The first data is at least two of: IQ samples from a radio front end, sounding reference signal (SRS) data, functional application platform interface (FAPI) messaging, radio link control (RLC) data, or medium access control (MAC) data. In aspects, the processor is further configured to, based on estimating the location and mobility type for the at least one UE, change at least one RAN parameter in real time to improve the RAN. Numerous other aspects are provided.

### BRIEF DESCRIPTION OF THE DRAWINGS

FIG. 1 illustrates monitoring hooks and hook points in CU/DU network functions and open air interface, in accordance with some embodiments.

FIG. 2 illustrates Extended Berkely Packet Filter (eBPF) technology for monitoring dynamic tracing, debugging and monitoring of data which may be used in accordance with some aspects.

FIG. 3 illustrates a first set of scenarios that may exist among RANs that may be improved by the present methods and apparatus, in accordance with some embodiments.

FIG. 4 illustrates a second set of scenarios that may exist among RANs that may be improved by the present methods and apparatus, in accordance with some embodiments.

FIG. 5 illustrates a third set of scenarios that may exist among RANs that may be improved by the present methods and apparatus, in accordance with some embodiments.

FIG. 6 illustrates logical system blocks to improve a RAN, in accordance with some embodiments.

FIG. 7 illustrates an exemplary method of improving a RAN in accordance with some embodiments.

FIG. 8 is a schematic diagram of an OpenRAN core architecture, in accordance with some embodiments.

FIG. 9 is a schematic diagram of a multi-RAT RAN deployment architecture, in accordance with some embodiments.

### DETAILED DESCRIPTION

Abbreviations used in this disclosure:

CU-CP: This node handles RRC and the control plane part of the PDCP protocol.

This node communicates with DU over F1-C interface and with CU-UP over E1 interface as defined in 3GPP specifications.

CU-UP: This node handles user plane part of PDCP protocol and SDAP protocol. It communicates with CU-CP over E1 interface and with DU over F1-U interface.

SMO (Service management and orchestration): control of infra structure component like CPU/Memory and scale up and scale down operations.

DU (gNB-DU): 3GPP defined 5G access network element.

Methods and apparatus are proposed here to improve a RAN. For example, the present methods and apparatus may provide near real-time geolocation for a UE based on RAN measurements, without additional RRC event(s) like a location request. In aspects, the present methods and apparatus leverage RAN UE information that is available for any UE in the network. allowing the RIC (e.g., the near-RT RIC) to perform inference on collected data to estimate the location and/or the mobility type of the handset/UE. The power of these present methods and apparatus allow the RAN to locate (e.g., geolocate) the UE and then cluster various behavior with relevance to location to identify and/or isolate various situations like RLF. Additionally or alternatively, the present methods and apparatus may enable to a RAN to determine, reach and/or employ the better (e.g., the best) HO factors and/or parameters that will provide dynamic and accurate mobility thresholds for efficient RAN operation. Additionally or alternatively, the present methods and apparatus enable a RAN to use/maintain better (e.g., the most efficient) overhead to allow energy savings on coverage layer.

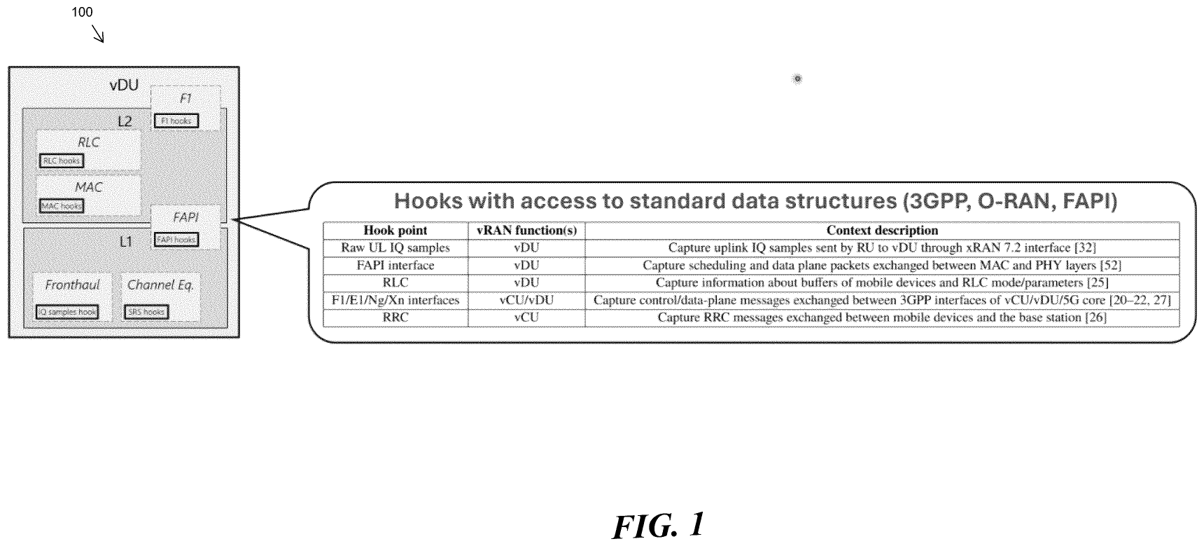

FIG. 1 illustrates monitoring hooks and hook points in CU/DU network functions and open air interfaces, in accordance with some embodiments. As part of the ability from Microsoft's project Janus, users are now able to collect data in real time without effect on RAN performance. Various statistics like IQ samples, FAPI, MAC, RLC, Xn, Ng and RRC data may be collected. Similar collection of data can be achieved by other methods utilizing the same open source infrastructure of eBPF. FIG. 1 illustrates exemplary hooks for various data points.

For example, various “hooks” (e.g., software interfaces which may involve data that are read out from memory) located at various points in the radio stack at the RAN are shown. In some embodiments, we can capture uplink IQ samples sent by RU to vDU through RAN 7.2 interlace Raw UL IQ samples at the vDU; capture scheduling and data plane packets exchanged between MAC and PHY layers FAPI interfaces at the vDU; capture information about butlers of mobile devices and RLC mode/parameters RIC at the vDU; capture control/data-plane messages exchanged between 3GPP interfaces of vCU/vDL/SG core F1/E1/Ng/Kn interfaces at the vCU and/or at the vDU; and/or capture RRC messages exchanged between mobile devices and the base station RRC at the vCU. In some embodiments the hooks may use privileged OS kernel software, such as Berkeley Packet Filter (BPF) or eBPF filtering, to extract data in real time, even from unmodified binaries, with minimal performance degradation. References to a CU below may also be a reference to a virtual (vCU). Similarly, references to a DU below may also be a reference to a virtual DU (vDU).

Regarding “at least one of IQ sample data, SRS data, FAPI data, RLC data or MAC data . . . ” IQ data is intercepted in the transceiver front end, i.e., this is raw radio samples before the data is even decoded into bits. The SRS data is 4G/5G channel estimation data that can be processed to glean information about the radio channel, specifically at least time of arrival, which can be used for determining location. FAPI data can include information about successful/unsuccessful attaches, retries, connections/disconnections, and signal strength, useful for understanding both current proximity to cells, identification of nearby cells, and change in signal for cells over time. RLC and MAC data can be used to determine connections/disconnections as well.

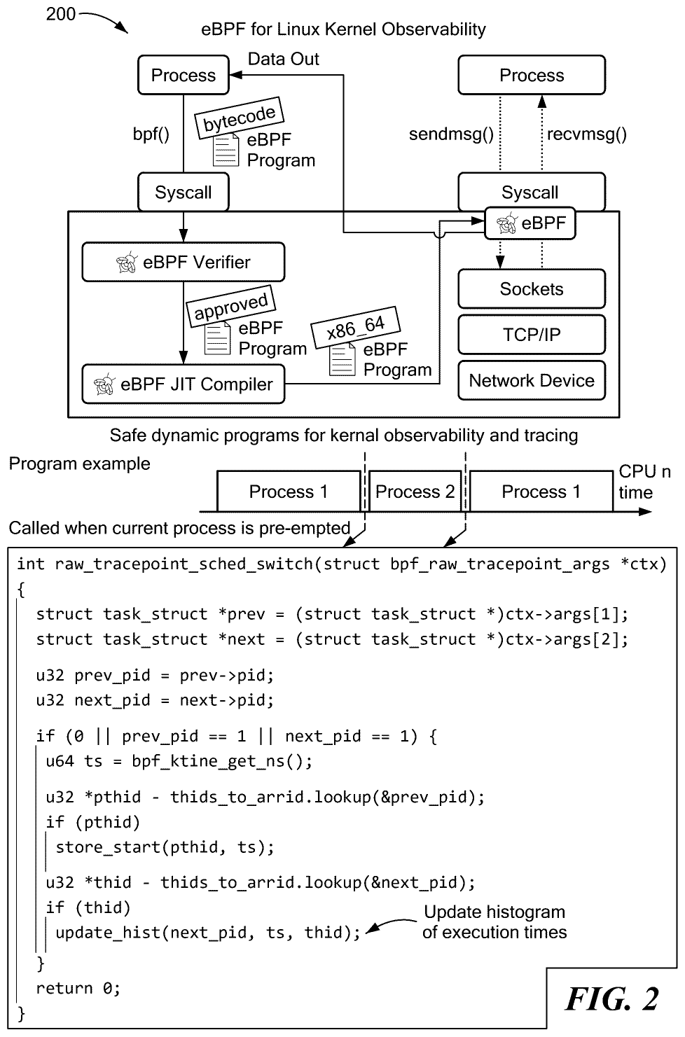

FIG. 2 illustrates Extended Berkeley Packet Filter (eBPF) technology 200 for monitoring dynamic tracing, debugging and monitoring of data which may be used in accordance with present aspects. In aspects, the eBPF technology 200 may be employed by the present methods and apparatus to collect data (e.g., the data described in FIG. 1).

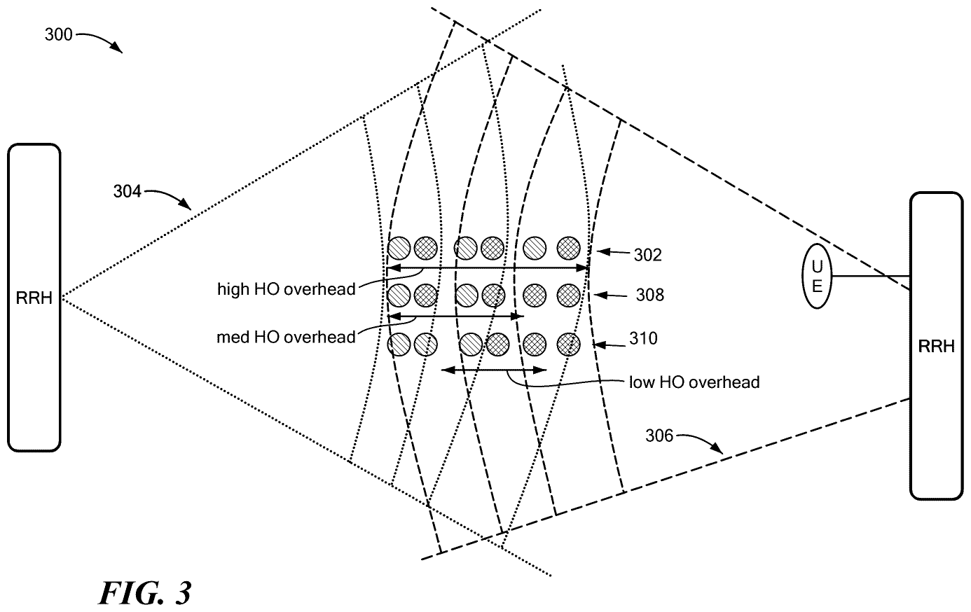

The present methods and apparatus may improve RANs by providing improved energy usage and/or improved parameters (e.g., network and/or UE parameters for handover). FIG. 3 illustrates a first set of scenarios 300 that may exist among RANs that may be improved by the present methods and apparatus, in accordance with some embodiments. In aspects, the present methods and apparatus may provide energy savings. In some networks, the coverage layer is one of the most untouched layers. The networks stay very static during the site life cycle. That is to say, even changes like CCO (cell coverage and capacity) are very static (e.g., trends of weeks) converting to results aiming to achieve the best coverage of the cell given the surroundings. This results eventually in coverage layer cells not following traffic patterns and staying as a safety net for the UE to be admitted to the network. Such stale network designs result in extremely high overhead of cell transition, like a handover HO. Networks can be found with values of above 2, which may indicate there is at least another cell that is fully shadowed by another cell's RSRP. HO overhead changes may be based on the beam power. Hence, same UE locations can be served by different source cells. Additionally or alternatively, higher coverage overlap by cells reduces the chance of mobility drop, while at the same time creating higher energy consumption. Lower coverage overlap by cells increases the chance of mobility drop, especially in the case of fast mobility, while improving the energy efficiency and savings. A first scenario 302 illustrates a first group of UEs (shown using hatching) coupled to a first cell 304, and a second group of UEs (shown using cross-hatching) coupled to a second cell 306 associated with a high HO overhead. A second scenario 308 illustrates a third group of UEs (shown using hatching) coupled to the first cell 304 and a fourth group of UEs (shown using cross-hatching) coupled to the second cell 306 associated with a medium HO overhead. A third scenario 310 illustrates a fifth group of UEs (shown using hatching) coupled to the first cell 304 and a sixth group of UEs (shown using cross-hatching) coupled to the second cell 306 associated with a low HO overhead. The present methods and apparatus will improve (e.g., optimize) the energy usage by one or more RANs by employing parameters based on the geolocation of one or more UEs in a RAN. The geolocation is based on the real-time network and/or UE data collected (e.g., as described in FIG. 1). In aspects, the location of the UE may not based on UE GPS data. In aspects, the UE location may be determined based RAN measurements without additional RRC events or functions like location request.

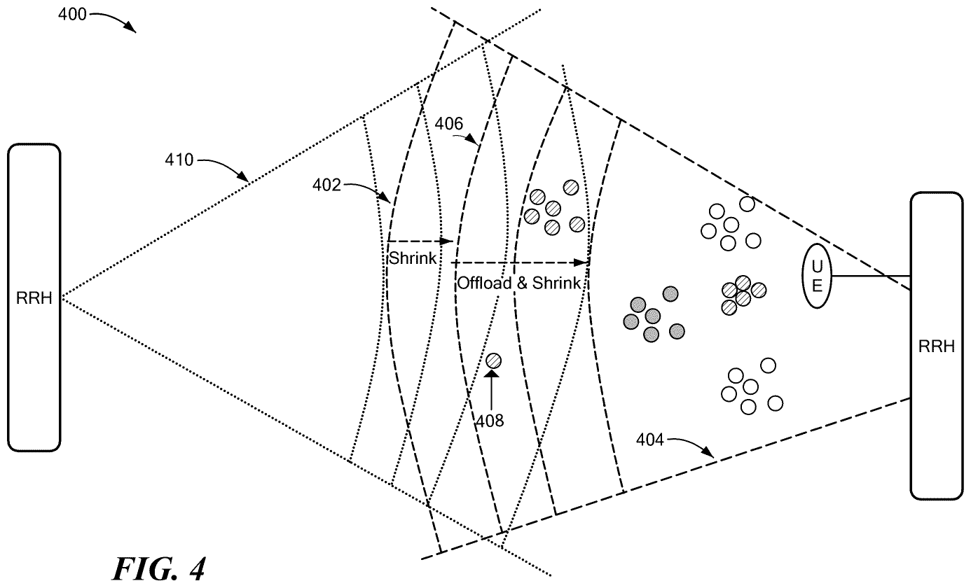

FIG. 4 illustrates a second set of scenarios 400 that may exist among RANs that may be improved by the present methods and apparatus, in accordance with some embodiments. In aspects, the present methods and apparatus may improve a RAN by providing improved UE mobility. The challenge with mobility improvement (e.g., optimization) is to find a better (e.g., the optimal) point for the UE to perform HO measurements for intra-/inter-frequency, as well as, IRAT cell transition. Criteria can be different based on cell coverage vs. a UE's distribution near a cell edge and the mobility speed of the UE. FIG. 4 illustrates a first scenario 402 in which a first cell 404 may shrink the first cell coverage area based on the present methods and apparatus. Additionally or alternatively, FIG. 4 illustrates a second scenario 406 in which the first cell 404 may offload at least one UE 408 being served by the first cell 404 to a second cell 408 while shrinking a coverage area of the first cell 404. In this manner, the second scenario 406 illustrates coverage shrink and offloading based on UE distribution. The present methods and apparatus may determine improved (e.g., optimal) handover and/or mobility parameters to compensate for the new cell footprint. For example, the present methods and apparatus may determine the improved handover and/or mobility parameters based on the real-time network and/or UE data collected.

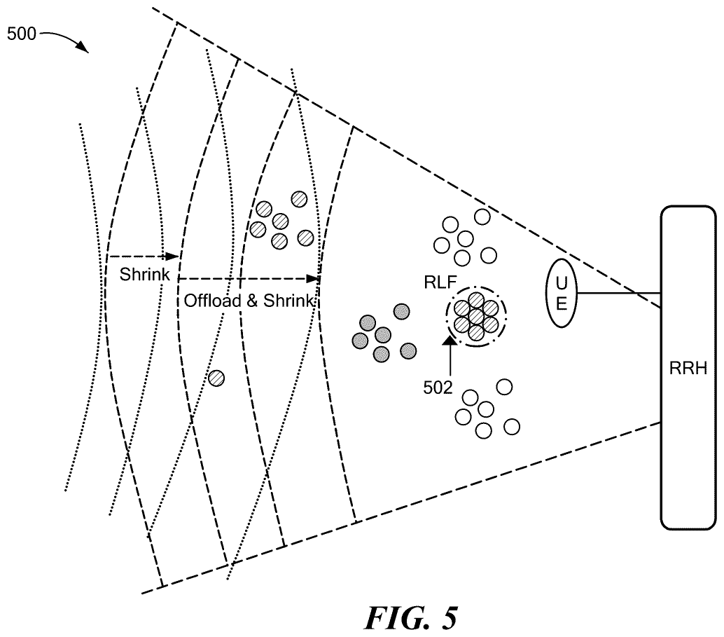

FIG. 5 illustrates a third set of scenarios 500 that may exist among RANs that may be improved by the present methods and apparatus, in accordance with some embodiments. In specific cases, like indoor optimization for cells in unique locations, the cell coverage is not distributed logically. In such cases, the closer the UE is to the cell site, does not always imply better coverage. Furthermore, coverage for a close-range UE may drastically be changed based on the few meters of physical location change. The above events leading eventually to radio link failure (RLF) at specific locations which require the ability to position the issues in the same geo cluster. FIG. 5 illustrates a geo shape in which UE that is close to the cell may still receive a RLF. In aspects, the present methods and apparatus may geoposition, geolocate and/or cluster areas 502 where UEs experience RLFs. In aspects, the present methods and apparatus may determine the geopositioning, geolocating and/or clustered area data based on the real-time network and/or UE data collected. The geopositioning, geolocating and/or clustered area data may be used to determine improved handover and/or mobility parameters thereby improving the RAN.

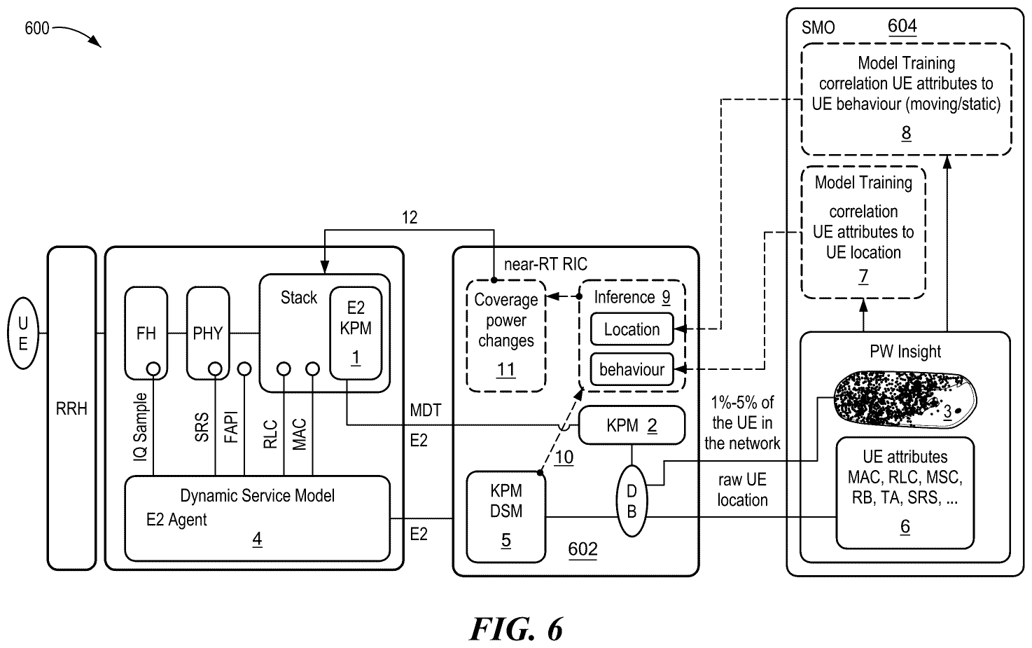

FIG. 6 illustrates logical system blocks 600 to improve a RAN, in accordance with some embodiments. In aspects, one goal is simply to be able to position (e.g., geolocate) a UE (e.g., all the UEs) in the given cell in near real-time. In aspects, the present methods and apparatus may locate (e.g., geolocate) a UE in a cell without the true GPS location data of the UE. In aspects, the present method and apparatus may improve a RAN despite the below restrictions
No information on the physical site location (or at least assume 10% gap in data)
No information terrain available
No additional UE reconfigurations for measurements
   In FIG. 6, at block 1, an E2 endpoint such as a DU, CU or base station may reconfigure and/or collect UE data (e.g., for GPS) (e.g., Minimization Drive Test (MDT) feature of 3GPP). Feasible to be collected on a range of +5% of total UEs in the network. At block 2, the E2 endpoint such as the DU, CU or base station may upload and send the data to the near-RT-RIC 602 (e.g., an xApp: KPM thereon) to extract transform and upload the data to a next layer. In aspects, basic data cleansing for abnormal measurements and/or enrichments with other cells for a case of neighbor (NBR) measurements may be provided. MSC, MAC, timing advance (TA) and/or other measurements may be provided. At block 3, the near-RT-RIC 602 may provide data raw UE location data (e.g., for 1-5% of the UEs in the network) to the SMO entity 604 for data lake 606 storage. In this manner, data for long periods of time and/or traffic patterns over a few days/weeks may be collected and stored. In aspects, the near-RT-RIC 602 may provide UE geolocation information, which does not include and/or is not based on GPS data or an RRC event like a location request. At block 4, the E2 endpoint such as the DU, CU or base station may collect the relevant RAN data using the hooks for inline code execution (e.g., utilizing eBPF technology and/or Microsoft-like technologies, such as project Janus). This allows the E2 endpoint to retrieve, for example, MAC, RLC, SRS, RB, and/or additional measurements from the L1, L2 and/or L3 layers.

At block 5, the near-RT-RIC 602 may collect and transform the data (e.g., using xApp: DSM). At block 6, the near-RT-RIC 602 may then upload such data to the SMO entity 604. The uploaded data may be stored on the data lake. For example, the information required to improve the RAN may be stored on the data lake. In aspects, the SMO entity 604 may perform data time alignment of UE-measured data and RAN-collected data. In aspects, the SMO entity 604 may normalize the measurements for the same granularity. At block 7, the present methods and apparatus may determine the required set of features to accurately detect the UE location based on the RAN data measurements (e.g., along with the importance of such features). In aspects, the SMO entity 604 may make such determination using AI technologies, such as neural networks. In aspects, the SMO entity 604 correlate or otherwise associate UE attributes to UE location. At block 8, the SMO entity 604 may use machine learning models for classification which provides the ability to detect based on the UE location changes and the RAN data measurements reflection accordingly. In aspects, the SMO entity 604 may correlate or otherwise associate UE attributes to UE behavior (e.g., mobility, including whether the UE is moving or static). In this manner, the present methods and apparatus may be able to achieve accurate UE classification for mobility types. At step 9, the SMO entity 604 may push inference models to the near-RT-RIC 602 (e.g., as additional xApp(s)) that will be utilized for the RAN measurements classification and location prediction. In aspects, the model is a cell/sector level evaluation and can change from one cell/sector/site to another.

At block 10, UE data measurements (e.g., without requests from KPM module 608) were collected on the fly and enriched by an inference model to provide the location and mobility type of each UE for a given cell. At block 611, detection and classification for UE (e.g., as being in one of the scenarios described above with reference to FIGS. 3-5) may be performed. In this manner, a UE may be classified as on a cell edge, in a cell having various geo-clusters of or associated with RLFs, and/or in shadowing scenarios for cells with high overlapping HO factor. In aspects, the present methods and apparatus may perform corrective actions in near real-time (e.g., by adjusting parameters like power) to improve (e.g., maximize) the energy efficiency of the RAN. Additionally or alternatively, the present methods and apparatus may adjust parameters at the UE level (e.g., resource block (RB), MSC, modulation and coding scheme (MCS), etc.) to improve end-user experience and link reliability. In aspects, the present methods and apparatus may apply such changes on RAN side.

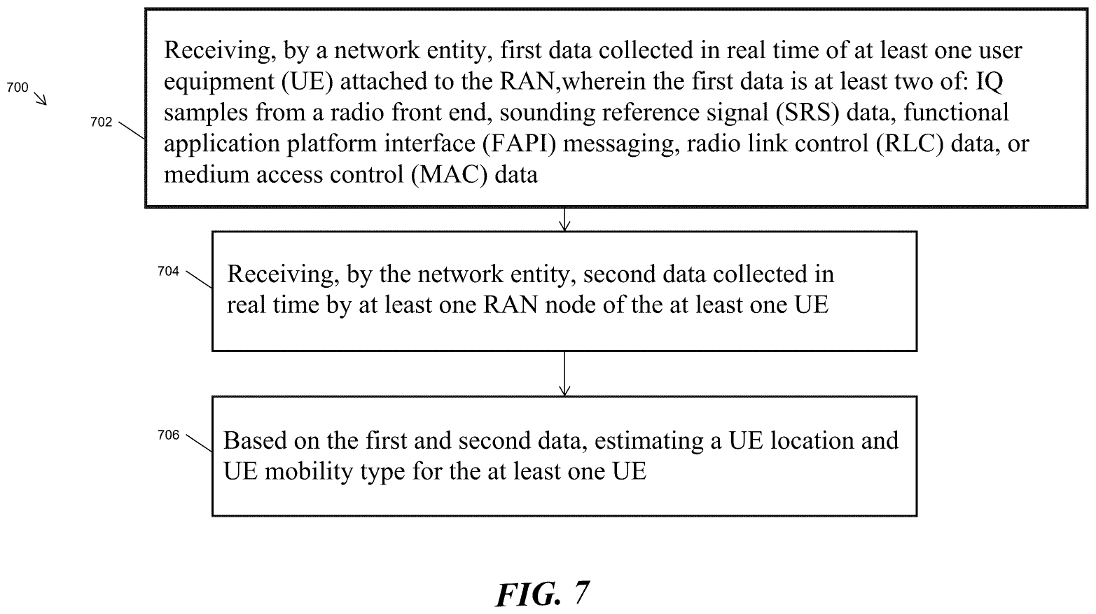

FIG. 7 illustrates an exemplary method of improving a RAN 700 in accordance with some embodiments. Step 702 of the method 700 includes receiving, by a network entity (e.g., a near-RT RIC), first data collected in real time of at least one user equipment (UE) attached to the RAN. Step 704 of the method 700 includes receiving, by the network entity, second data collected in real time by at least one RAN node of the at least one UE. Step 706 of the method 700 includes, based on the first and second data, estimating a UE location and UE mobility type for the at least one UE, wherein the first data is at least two of: IQ samples from a radio front end, sounding reference signal (SRS) data, functional application platform interface (FAPI) messaging, radio link control (RLC) data, or medium access control (MAC) data. In aspects, estimating the location and mobility type for the at least one UE includes determining the at least one UE is at a cell edge and has a high mobility, is at a cell area associated with a plurality of radio link failures and has a low mobility, or is in a cell area overlapped by another cell area and has low mobility. In aspects, the method 700 includes, based on estimating the location and mobility type for the at least one UE, changing at least one RAN parameter in real time to improve the RAN. In aspects, changing at least one RAN parameter in real time to improve the RAN includes changing at least one RAN power parameter.

In aspects, estimating a location and mobility type for the at least one UE includes associating at least one of the first data or second data to the UE location, and associating at least one of the first data or second data to the UE mobility type. In such aspects, associating at least one of the first data or second data to the UE location includes using artificial intelligence (AI) or machine learning (ML) models to correlate the at least one of the first data or second data to the UE location, and associating at least one of the first data or second data to the UE mobility type includes using AI or ML models to correlate the at least one of the first data or second data to the UE mobility type.

In aspects, the first data includes raw location data for the at least one UE. In aspects, the second data includes at least one of IQ sample data, SRS data, FAPI data, RLC data or MAC data associated with the at least one UE. In aspects, the method 700 further comprises storing at least one of a processed version of the first data or a processed version of the second data in a data lake. Although one or more steps of the present methods are described as being performed by the near-RT RIC 602, another network entity (e.g., an eNodeB) or a combination of network entities may perform such methods. Similarly, although one or more portions of the present apparatus are described with reference to the near-RT RIC 602, the present apparatus may include another network entity (e.g., an eNodeB) or a combination of network entities.

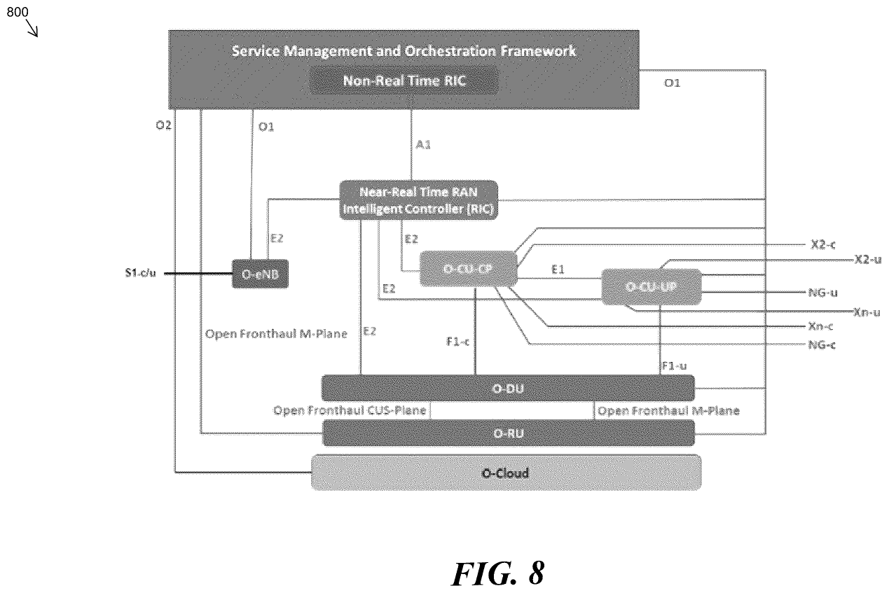

FIG. 8 is a schematic diagram of an OpenRAN core architecture 800, in accordance with some embodiments. The present disclosure is enabled for use with the disclosed architecture in this figure. The O-RAN deployment architecture includes an O-DU and O-RU, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller (non-RT RIC) is shown, receiving inputs from throughout the network and specifically from the near-RT RIC and performing service management and orchestration (SMO) or operations administration maintenance (OAM) server, in coordination with the operator's network. Various nodes, for example the CU-CP and CU-UP nodes (here marked O-CU-CP and O-CU-UP to denote OpenRAN-compatible nodes), use SCTP and may use the methods and systems described herein for SCTP high availability. In some embodiments, a containerized architecture may be used and may provide the benefits of such an architecture to any of the higher layers and nodes, e.g., O-XXX, Near-RT RIC, etc. of this architecture as shown in the figure, in some embodiments.

As shown, the non-RT RIC, which is providing the OAM, receives data and collects it during operation of the network; and, at appropriate intervals, may perform a process that results in evaluating the performance of the network with respect to one or more eNodeB, gNodeB, or other E2-compliant base stations and requesting an E2 reset for certain E2-compliant base stations. The E2 reset is requested from the near-RT RIC shown near the center of the figure, and the near-RT RIC completes the process as described herein. Various different implementations of this architecture are contemplated which retain the logical separation shown in this figure between OAM, near-RT RIC, and base station.

In some embodiments, Service Management and Orchestration Framework (SMO) hosts EMS/OAM UI function, where Operator can periodically monitor statistics collected from Near RT RIC and also from E2 nodes via O1 interface.

It is understood that the present methods and apparatus also applies to non-ORAN architectures.

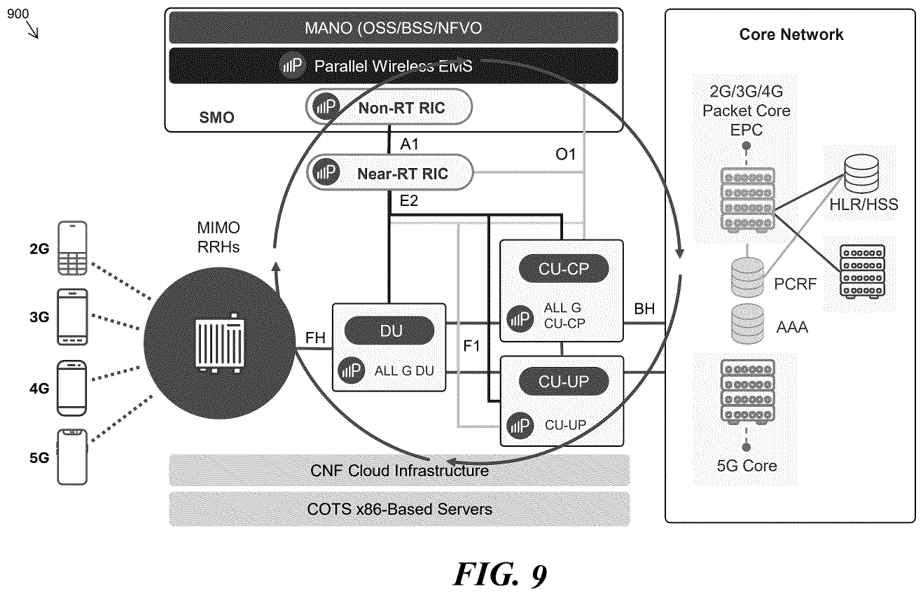

FIG. 9 is a schematic diagram of a multi-RAT RAN deployment architecture 900, in accordance with some embodiments. The architecture shown is an ORAN-compliant architecture that also enables other radio access technologies (RATs), e.g., 2G and 3G, to interoperate and be coordinated by the non-RT RIC and near-RT RIC shown above in FIG. 4. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G, in some embodiments. Here, the node labeled “SMO/MANO (OSS/BSS/NFVO)” provides OAM functionality as described herein and can interface with the near-RT RIC to initiate an E2 reset as described herein. In some embodiments, an A1 interface or a NETCONF interface between the non-RT RIC and near-RT RIC may be used for this purpose.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

The protocols described herein have largely been adopted by the 3GPP as a standard for the upcoming 5G network technology as well, in particular for interfacing with 4G/LTE technology. For example, X2 is used in both 4G and 5G and is also complemented by 5G-specific standard protocols called Xn. Additionally, the 5G standard includes two phases, non-standalone (which will coexist with 4G devices and networks) and standalone, and also includes specifications for dual connectivity of UEs to both LTE and NR (“New Radio”) 5G radio access networks. The inter-base station protocol between an LTE eNB and a 5G gNB is called Xx. The specifications of the Xn and Xx protocol are understood to be known to those of skill in the art and are hereby incorporated by reference dated as of the priority date of this application.

In some embodiments, an internal controller keeps track of health of some or all pods & micro services in a given namespace. As soon as any pod/container crashes, it updates the remaining pods. And takes necessary steps to bring system in workable state.

In some embodiments, a database (Service registry) may act as service registry database for some or all pods and microservice in given namespace. All the pods on start-up can update required information in database & fetch required information from service registry database.

In some embodiments, the near-RT RIC may be an all-G or multi-RAT near-RT RIC. In other words, the near-RT RIC may perform processing and network adjustments that are appropriate given one or more applicable RATs. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

Although an A1 interface and a NETCONF interface are described between the near-RT RIC and the non-RT RIC, any other appropriate interface may be used to communicate between the near-RT RIC and the non-RT RIC. It is understood that in some embodiments a 2G, 3G, or other RAT node could also be capable of receiving and performing E2 resets; and such nodes could be managed using the systems and methods described herein.

Although the above systems and methods for policy provisioning are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to 5G networks, LTE-compatible networks, to UMTS-compatible networks, or to networks for additional protocols that utilize radio frequency data transmission. Various components in the devices described herein may be added, removed, or substituted with those having the same or similar functionality. Various steps as described in the figures and specification may be added or removed from the processes described herein, and the steps described may be performed in an alternative order, consistent with the spirit of the invention.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method of improving a radio access network (RAN), comprising:
receiving, by a network entity, first data collected in real time of at least one user equipment (UE) attached to the RAN;
receiving, by the network entity, second data collected in real time by at least one RAN node of the at least one UE; and
based on the first and second data, estimating a UE location and UE mobility type for the at least one UE,
wherein the first data is at least two of: IQ samples from a radio front end, sounding reference signal (SRS) data, functional application platform interface (FAPI) messaging, radio link control (RLC) data, or medium access control (MAC) data.

2. The method of claim 1, wherein estimating the location and mobility type for the at least one UE includes:
determining the at least one UE is at a cell edge and has a high mobility, is at a cell area associated with a plurality of radio link failures and has a low mobility, or is in a cell area overlapped by another cell area and has low mobility.

3. The method of claim 1, further comprising based on estimating the location and mobility type for the at least one UE, changing at least one RAN parameter in real time or non-real time to improve RAN performance.

4. The method of claim 1, wherein the second data includes at least one of IQ sample data, SRS data, FAPI data, RLC data or MAC data associated with the at least one UE.

5. The method of claim 1, wherein estimating a location and mobility type for the at least one UE includes:
associating at least one of the first data or second data to the UE location; and
associating at least one of the first data or second data to the UE mobility type.

6. The method of claim 5, wherein:
associating at least one of the first data or second data to the UE location includes using at least one of neural network, machine learning (ML), or inference models to correlate the at least one of the first data or second data to the UE location; and
associating at least one of the first data or second data to the UE mobility type includes using the models to correlate the at least one of the first data or second data to the UE mobility type.

7. The method of claim 1, further comprising storing at least one of a processed version of the first data or a processed version of the second data in a data lake.

8. The method of claim 1, wherein changing at least one RAN parameter in real time to improve the RAN includes changing at least one RAN power parameter.

9. A non-transitory computer-readable medium comprising instructions for improving a radio access network (RAN) which, when executed, cause a system to perform steps, comprising:
receiving, by a network entity, first data collected in real time of at least one user equipment (UE) attached to the RAN;
receiving, by the network entity, second data collected in real time by at least one RAN node of the at least one UE; and
based on the first and second data, estimating a UE location and UE mobility type for the at least one UE,
wherein the first data is at least two of: IQ samples from a radio front end, sounding reference signal (SRS) data, functional application platform interface (FAPI) messaging, radio link control (RLC) data, or medium access control (MAC) data.

10. The computer-readable medium of claim 9, further comprising instructions which, when executed, cause the system to perform the step of determining the at least on UE is at a cell edge and has a high mobility, is at a cell area associated with a plurality of radio link failures and has a low mobility, or is in a cell area overlapped by another cell and has low mobility.

11. The computer-readable medium of claim 9, further comprising instructions which, when executed, cause the system to perform steps of, based on estimating the location and mobility type for the at least one UE, changing at least one RAN parameter in real time or non-real time to improve RAN performance.

12. The computer-readable medium of claim 9, wherein the second data includes at least one of IQ sample data, SRS data, FAPI data, RLC data or MAC data associated with the at least one UE.

13. The computer-readable medium of claim 9, further comprising instructions which, when executed, cause the system to perform the steps of:
associating at least one of the first data or second data to the UE location; and
associating at least one of the first data or second data to the UE mobility type.

14. The computer-readable medium of claim 13, further comprising instructions which, when executed, cause the system to perform the steps of:
associating at least one of the first data or second data to the UE location includes using artificial intelligence (AI) models to correlate the at least one of the first data or second data to the UE location; and
associating at least one of the first data or second data to the UE mobility type includes using AI models to correlate the at least one of the first data or second data to the UE mobility type.

15. A network entity, comprising:
a memory; and
a processor coupled to the memory, the processor configured to:
receive first data collected in real time of at least one user equipment (UE) attached to the RAN;
receive second data collected in real time by at least one RAN node of the at least one UE; and
based on the first and second data, estimate a UE location and UE mobility type for the at least one UE,
wherein the first data is at least two of: IQ samples from a radio front end, sounding reference signal (SRS) data, functional application platform interface (FAPI) messaging, radio link control (RLC) data, or medium access control (MAC) data.

16. The network entity of claim 15, wherein the processor is further configured to determine the at least on UE is at a cell edge and has a high mobility, is at a cell area associated with a plurality of radio link failures and has a low mobility, or is in a cell area overlapped by another cell and has low mobility.

17. The network entity of claim 15, wherein the processor is further configured to:
associate at least one of the first data or second data to the UE location; and
associate at least one of the first data or second data to the UE mobility type.

18. The network entity of claim 17, wherein the processor is further configured to:
use artificial intelligence (AI) or machine learning (ML) models to correlate the at least one of the first data or second data to the UE location; and
use AI or ML models to correlate the at least one of the first data or second data to the UE mobility type.

19. The network entity of claim 15, wherein the processor is further configured to change at least one RAN power parameter.

20. The network entity of claim 15, wherein the at least one RAN node includes at least one of a centralized unit of the RAN or a distributed unit of the RAN.
